(19) United States
(12) Patent Application Publication
(10) Pub. No.: US 2018/0244527 A1
(43) Pub. Date: Aug. 30, 2018

(54) POLYCRYSTALLINE SILICON ROD

(71) Applicant: Shin-Etsu Chemical Co., Ltd., Tokyo (JP)

(72) Inventors: Shuichi Miyao, Niigata (JP); Junichi Okada, Niigata (JP); Shigeyoshi Netsu, Niigata (JP)

(73) Assignee: Shin-Etsu Chemical Co., Ltd., Tokyo (JP)

(21) Appl. No.: 15/754,348

(22) PCT Filed: Aug. 2, 2016
(86) PCT No.: PCT/JP2016/072595

§ 371 Date: Feb. 22, 2018

(30) Foreign Application Priority Data
Sep. 14, 2015 (JP) 2015-180942

(51) Int. Cl. C01B 33/02; G01B 15/00; G01N 23/20058

(52) U.S. Cl. CPC C01B 33/02; G01B 15/00; C01P 2002/70; C01P 2002/60; G01N 23/20058

(57) ABSTRACT

A polycrystalline silicon rod grown from monosilane as a raw material, having a crystal grain diameter in the range of 0.5 to 10 μm, with an average grain diameter in the range of 2 to 3 μm, as determined from an electron backscatter diffraction image obtained by irradiating a principal plane of a plate-like specimen collected from an arbitrary site with an electron beam, the principal plane being a cross-section perpendicular to the radial direction of the polycrystalline silicon rod, has a good FZ, L % value. The polycrystalline silicon rod further having a thermal diffusivity value measured on the principal plane of the plate-like specimen in the range of 75 to 85 mm²/sec at 25±1° C. has a good FZ, L % value and is suitable as a raw material for single crystallization.

### TECHNICAL FIELD

The present invention relates to a polycrystalline silicon rod suitable as a raw material for manufacturing monocrystalline silicon.

### BACKGROUND ART

Monocrystalline silicon that is essential in manufacturing semiconductor devices and the like is made by crystal growth using a polycrystalline silicon rod or a polycrystalline silicon ingot as a raw material in a CZ method or an FZ method. Such a polycrystalline silicon material is manufactured by the Siemens method in many cases.

The Siemens method includes letting a silane source gas such as trichlorosilane and monosilane and hydrogen come in contact with a heated silicon core so as to achieve vapor deposition (precipitation) of polycrystalline silicon on the surface of the silicon core by chemical vapor deposition (CVD).

In the case of crystal growth of monocrystalline silicon by a CZ method, for example, polycrystalline silicon ingots obtained by crushing a polycrystalline silicon rod synthesized from trichlorosilane are put in a quartz crucible, and heated to make a silicon melt. A seed crystal is immersed in the melt for a dislocation line to disappear. After a dislocation-free state is achieved, the crystal is pulling up with the diameter gradually enlarged to a predetermined diameter.

On this occasion, if unmelted polycrystalline silicon remains in the silicon melt, the unmelted polycrystalline pieces drift near the solid-liquid interface by convection, so that the generation of dislocations is induced, resulting in disappearance or disarrangement of a crystal line.

In the case of using a polycrystalline silicon rod synthesized from trichlorosilane as a raw material, investigational results on the effects of physical properties such as the crystallinity and crystal orientation thereof on single crystallization of FZ silicon are disclosed in Patent Literature 1 to 4.

The physical properties of polycrystalline silicon synthesized from monosilane as a raw material are different from the physical properties of polycrystalline silicon synthesized from trichlorosilane as a raw material. The reason is that monosilane has no chlorine element in the structure, so that no hydrochloric acid is by-produced during growth by CVD. Under an environment without generation of hydrochloric acid, no etching effect is produced when the polycrystalline silicon is precipitated, so that the CVD growth rate is enhanced. The thermal decomposition temperature is therefore low. For example, while the CVD temperature of trichlorosilane is about 1000 to 1150° C., the polycrystalline silicon is precipitated at a CVD temperature of about 900° C. Due to the difference in the precipitation temperature, difference appears in characteristics of the obtained polycrystalline silicon.

### CITATION LIST

### Patent Literature

Patent Literature 1: International Publication No. WO 2012/164803 A1

Patent Literature 2: Japanese Patent Laid-Open No. 2013-217653

Patent Literature 3: Japanese Patent Laid-Open No. 2014-1096

Patent Literature 4: Japanese Patent Laid-Open No. 2014-34506

### SUMMARY OF INVENTION

### Technical Problem

As described above, polycrystalline silicon synthesized from monosilane has a lower CVD temperature in comparison with those synthesized from trichlorosilane, so that the crystallinity, crystal physical properties, residual stress, and thermal diffusivity are different from those of polycrystalline silicon synthesized from trichlorosilane. Inevitably, the method for selecting a polycrystalline silicon rod grown from monosilane as a raw material in manufacturing monocrystalline silicon is also different.

In the light of these circumstances, an object of the present invention is, in manufacturing a raw material for manufacturing monocrystalline silicon from a polycrystalline silicon rod synthesized from monosilane, to provide a technique for selecting the polycrystalline silicon rod suitable as a raw material for single crystallization so that stable manufacturing of monocrystalline silicon can be achieved.

### Solution to Problem

In order to solve the above described problem, the polycrystalline silicon rod of the present invention is grown from monosilane as a raw material, having a crystal grain diameter in the range of 0.5 to 10 μm, with an average grain diameter in the range of 2 to 3 μm, as determined from an electron backscatter diffraction image obtained by irradiating the principal plane of a plate-like specimen collected from an arbitrary site with an electron beam, the principal plane being a cross-section perpendicular to the radial direction of the polycrystalline silicon rod.

Preferably, the thermal diffusivity value measured on the principal plane of the plate-like specimen is in the range of 75 to 85 mm²/sec at 25±1° C.

Also, preferably, the coefficients of variation CV₁⁽¹¹¹⁾ and CV₁⁽²²⁰⁾ of the averages of Bragg reflection intensity from Miller index planes (111) and (220) are 10% or less, and the coefficient of variation CV₂ of the intensity ratio of the average of Bragg reflection intensity of the Miller index plane (111) to the average of Bragg reflection intensity of the Miller index plane (220) obtained for each of a plurality of plate-like specimens is 3% or less, wherein the plurality of the plate-like specimens with a cross-section perpendicular to the radial direction of the polycrystalline silicon rod as the principal plane are collected from different sites of the polycrystalline silicon rod; each of the collected plate-like specimens is arranged at a position where the Bragg reflection from the Miller index planes (111) and (220) can be detected; the plate-like specimen is in-plane rotated at a rotation angle φ with the center of the plate-like specimen as the center of rotation, such that an X-ray irradiation region defined by a slit φ-scans on the principal plane of the plate-like specimen; a chart showing the dependence of the Bragg reflection intensity from the Miller index planes (111) and (220) on the rotation angle (φ) of the plate-like specimen is obtained; and the averages of the Bragg reflection intensity appearing in the chart from the Miller index planes (111) and (220) are obtained for each of plate-like specimens.

Also, preferably, when any of the plurality of the plate-like specimens is collected from a region near the surface of the polycrystalline silicon rods, the coefficients of variation CV₁⁽¹¹¹⁾ and CV₁⁽²²⁰⁾ of the averages of the Bragg reflection intensity from the Miller index planes (111) and (220) are 4% or less, and the coefficient of variation CV₂ of the intensity ratio of the average of the Bragg reflection intensity of the Miller index plane (111) to the average of the Bragg reflection intensity of the Miller index plane (220) is in the range of 1.3 to 2.2%.

Further, preferably, a residual stress measurement result of the plate-like specimen by X-ray diffraction indicates compression, and a residual stress measurement result of a plate-like specimen having a cross-section perpendicular to the axial direction of the polycrystalline silicon rod as the principal plane by X-ray diffraction also indicates compression.

### Advantageous Effects of Invention

According to the present invention, in manufacturing a raw material for manufacturing monocrystalline silicon from a polycrystalline silicon rod synthesized from monosilane, the polycrystalline silicon rod suitable as a raw material for single crystallization is provided by selecting the polycrystalline silicon rod based on the conditions described above.

### BRIEF DESCRIPTION OF DRAWINGS

FIG. 1A is a schematic view illustrating an example of plate-like specimens for X-ray diffraction measurement collected from a polycrystalline silicon rod precipitated and grown by chemical vapor deposition.

FIG. 1B is a schematic view illustrating an example of plate-like specimens for X-ray diffraction measurement collected from a polycrystalline silicon rod precipitated and grown by chemical vapor deposition.

FIG. 2 is a schematic view illustrating an example of a measurement system for obtaining an X-ray diffraction profile from a plate-like specimen by a θ-2θ method.

FIG. 3 is a schematic view illustrating an example of a measurement system for obtaining an X-ray diffraction profile from a plate-like specimen by φ scanning.

FIG. 4 is a schematic view illustrating another example of a measurement system for obtaining an X-ray diffraction profile from a plate-like specimen by φ scanning.

FIG. 5 is a schematic view illustrating yet another example of a measurement system for obtaining an X-ray diffraction profile from a plate-like specimen by φ scanning.

### DESCRIPTION OF EMBODIMENTS

In the course of study for improving the quality of polycrystalline silicon to achieve stable manufacturing of monocrystalline silicon, the present inventors have focused on the difference in characteristics between a polycrystalline silicon rod obtained from precipitation on a silicon core using monosilane as a raw material and those synthesized from trichlorosilane, and investigated a method for selecting a polycrystalline silicon rod suitable as a raw material for single crystallization in manufacturing raw material for manufacturing monocrystalline silicon from a polycrystalline silicon rod synthesized from monosilane.

Specifically, in the case of the growth of an FZ silicon single crystal from a raw material polycrystalline silicon rod synthesized from monosilane, the crystal line as a mark of dislocation-free growth may not disappear; the crystal line may disappear in the process; or the crystal line may cause disarrangement, though not disappearing; depending on the polycrystalline silicon rod for use. The present inventors have analyzed the phenomenon and confirmed that a yield of 98 to 100% can be obtained by selecting the polycrystalline silicon rod under the following conditions for use as a raw material for growing an FZ silicon single crystal.

The yield referred here means the ratio of the length from the start position of the FZ single crystallization to a position where the crystal line disappears or causes disarrangement in a single FZ operation relative to the whole length of a polycrystalline silicon rod used as a raw material. In other words, when no disappearance or disarrangement of the crystal line occurs, the yield is 100%. Hereinafter, the yield is expressed as FZ, L (%).

According to the investigation of the present inventors, a polycrystalline silicon rod suitable as a raw material for manufacturing monocrystalline silicon satisfies the following conditions.

More specifically, the polycrystalline silicon rod is grown from monosilane as a raw material, having a crystal grain diameter in the range of 0.5 to 10 μm, with an average grain diameter in the range of 2 to 3 μm, as determined from an electron backscatter diffraction image obtained by irradiating the principal plane of a plate-like specimen collected from any site with an electron beam, the principal plane being a cross-section perpendicular to the radial direction of the polycrystalline silicon rod.

Preferably, the polycrystalline silicon rod has a thermal diffusivity value measured on the principal plane of the plate-like specimen in the range of 75 to 85 mm²/sec at 25±1° C.

Also, preferably, the polycrystalline silicon rod has coefficients of variation CV₁⁽¹¹¹⁾ and CV₁⁽²²⁰⁾ of the averages of Bragg reflection intensity from Miller index planes (111) and (220) of 10% or less, and the coefficient of variation CV₂ of the intensity ratio of the average of Bragg reflection intensity of the Miller index plane (111) to the average of Bragg reflection intensity of the Miller index plane (220) obtained for each of a plurality of the plate-like specimens of 3% or less; wherein the plurality of the plate-like specimens with a cross-section perpendicular to the radial direction of the polycrystalline silicon rod as the principal plane are collected from different sites of the polycrystalline silicon rod; each of the collected plate-like specimens is arranged at a position where the Bragg reflection from the Miller index planes (111) and (220) can be detected; the plate-like specimen is in-plane rotated at a rotation angle φ with the center of the plate-like specimen as the center of rotation, such that an X-ray irradiation region defined by a slit φ-scans on the principal plane of the plate-like specimen; a chart showing the dependence of the Bragg reflection intensity from the Miller index planes (111) and (220) on the rotation angle (φ) of the plate-like specimen is obtained; and the averages of the Bragg reflection intensity appearing in the chart from the Miller index planes (111) and (220) are obtained for each of the plate-like specimens.

Also, preferably, when any of the plurality of the plate-like specimens is collected from a region near the surface of the polycrystalline silicon rod, the polycrystalline silicon rod has the coefficients of variation CV₁⁽¹¹¹⁾ and CV₁⁽²²⁰⁾ of the averages of Bragg reflection intensity from the Miller index planes (111) and (220) of 4% or less; and the coefficient of variation CV₂ of the intensity ratio of the average of the Bragg reflection intensity of the Miller index plane (111) to the average of the Bragg reflection intensity of the Miller index plane (220) is in the range of 1.3 to 2.2%.

Further, preferably, the polycrystalline silicon rod allows a residual stress measurement result of the plate-like specimen by X-ray diffraction to indicate compression, and a residual stress measurement result of a plate-like specimen having a cross-section perpendicular to the axial direction of the polycrystalline silicon rod as the principal plane by X-ray diffraction also to indicate compression.

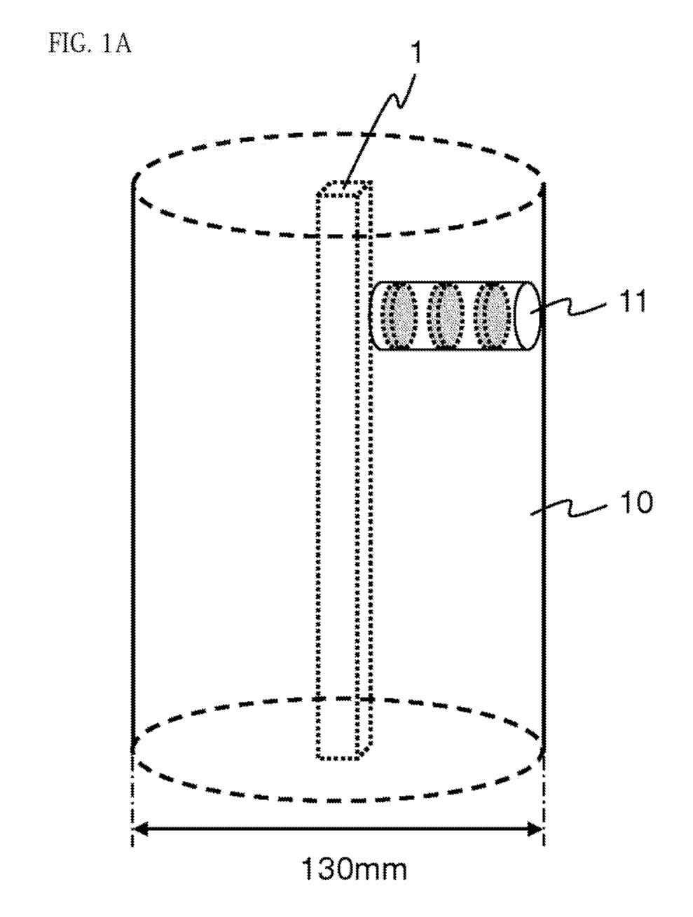

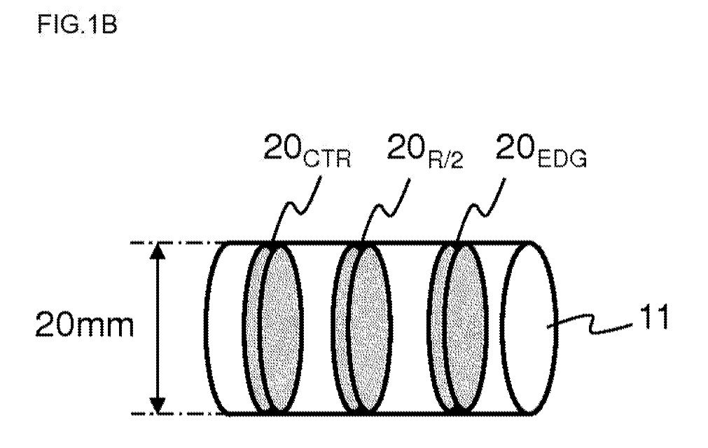

FIGS. 1A and 1B are schematic views illustrating examples of plate-like specimens 20 for X-ray diffraction profile measurement collected from a polycrystalline silicon rod 10 precipitated and grown by chemical vapor deposition such as the Siemens method using monosilane as a raw material. A silicon core 1 in the Figures is used to make a silicon rod by precipitation of polycrystalline silicon on the surface. Although the plate-like specimens 20 are collected from 3 sites (CTR: site close to the silicon core 1, EDG: site close to the side of polycrystalline silicon rod 10, R/2: site in the middle between CTR and EDG) in this example to check whether the crystal orientation of a polycrystalline silicon rod depends on the radial distance, the sites where specimens are collected from are not limited to such sites.

In the present invention, a plurality of plate-like specimens having a cross-section perpendicular to the redial direction of a polycrystalline silicon rod as the principal plane are collected from arbitrary sites, and the values obtained from X-ray diffraction profiles are statistically processed. On this occasion, the presence of at least 5 data sets is preferred for calculating a coefficient of variation statistically. The reason is that although the calculation of standard deviation σn−1 is required to determine CV %, the standard deviation depends on the number n (number of data sets), so that with a number n of less than 5, the apparent value decreases, causing difficulty in proper evaluation. In contrast, with a number n of 5 or more, the effect can be ignored. Preferably the specimens are collected to have a number n of 10 or more.

Accordingly, for example, as shown in FIGS. 1A and 1B, plate-like specimens (20_{CTR}, 20_{EDG}, 20_{R/2}) are collected from a site closest to the silicon core (CTR), a site close to the side of polycrystalline silicon rod (EDG), and a site in the middle between CTR and EDG (R/2), respectively. Although only 3 plate-like specimens are shown in the Figures, the plate-like specimens are also collected from the symmetrical positions of the sampling positions of the plate-like specimens (20_{CTR}, 20_{EDG}, 20_{R/2}) in the same manner, so as to obtain the sufficient number n. In the example shown in the Figures, a total of 6 plate-like specimens are therefore collected.

The polycrystalline silicon rod 10 illustrated in FIG. 1A has a diameter of about 130 mm. From the side of the polycrystalline silicon rod 10, a rod 11 having a diameter of about 20 mm and a length of about 65 mm is cut out in the direction perpendicular to the longitudinal direction of the silicon core 1.

As shown in FIG. 1B, plate-like specimens (20_{CTR}, 20_{EDG}, 20_{R/2}) having a cross-section perpendicular to the redial direction of a polycrystalline silicon rod 10 as the principal plane with a thickness of about 2 mm are then collected from a region close to the silicon core 1 of the rod 11 (CTR), a region close to the side of the polycrystalline silicon rod 10 (EDG), and a region in the middle between CTR and EDG (R/2), respectively.

A site where the rod 11 is collected, the length and the number of the rod 11 may be appropriately determined corresponding to the diameter of the silicon rod 10 and the diameter of the rod 11 to be cut out. Although the plate-like specimens 20 may be collected from any site of the cutout rod 11, the position from which the characters of the entire silicon rod 10 are reasonably estimated is preferred.

Although the plate-like specimen 20 has a diameter of about 20 mm in an example, the diameter may be appropriately determined within the range that is acceptable in X-ray diffraction measurement.

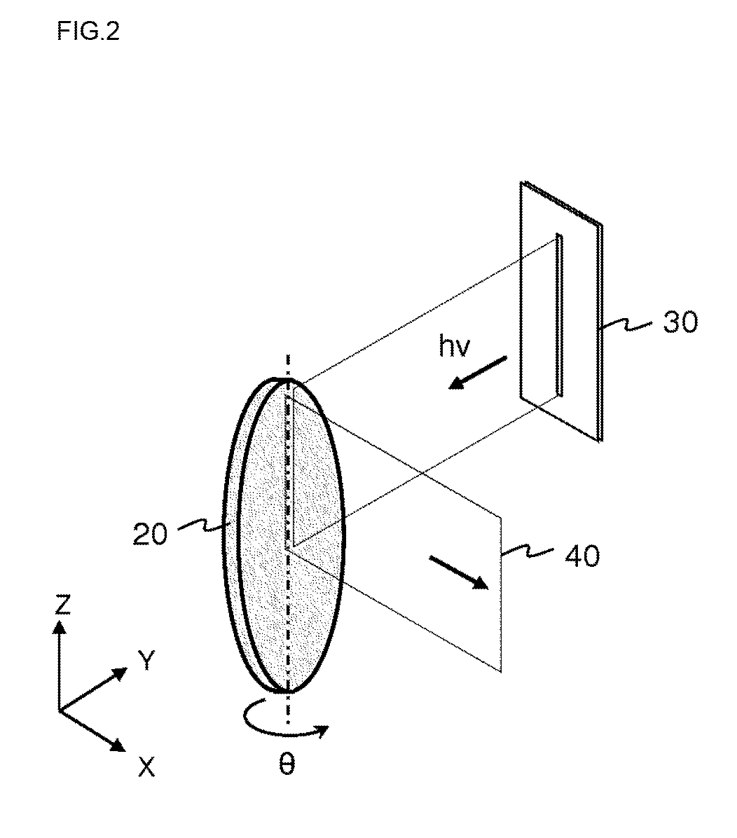

FIG. 2 is a schematic view illustrating an example of a measurement system for obtaining an X-ray diffraction profile from a plate-like specimen 20 by a θ-2θ method. A collimated X-ray beam 40 (Cu-Kα radiation, wavelength: 1.54 Å) emitted from a slit 30 enters the plate-like specimen 20. While the plate-like specimen 20 is rotated in the XY plane, the intensity of the diffracted X-ray beam per rotation angle (θ) of the specimen is detected by a detector (not shown in drawing) to obtain a θ-2θ X-ray diffraction chart.

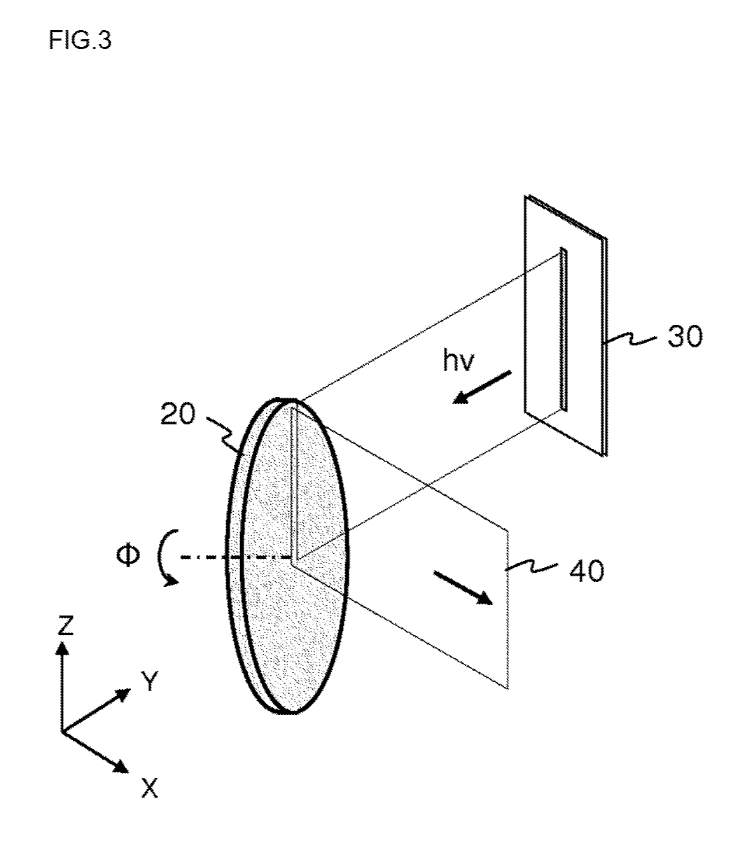

FIG. 3 is a schematic view illustrating a measurement system for obtaining an X-ray diffraction profile from a plate-like specimen 20 by so-called φ scanning. For example, the θ of a plate-like specimen 20 is defined as the angle at which the Bragg reflection from the Miller index plane (111) is detected, and a slim rectangular region defined by a slit is irradiated with an X-ray, on the region extending from the center to the circumferential edge of the plate-like specimen 20 in that condition. The plate-like specimen 20 is rotated with the center thereof as the center of rotation within the YZ plane (φ=0° to 360°), such that the X-ray-irradiated region scans the whole surface of the plate-like specimen 20.

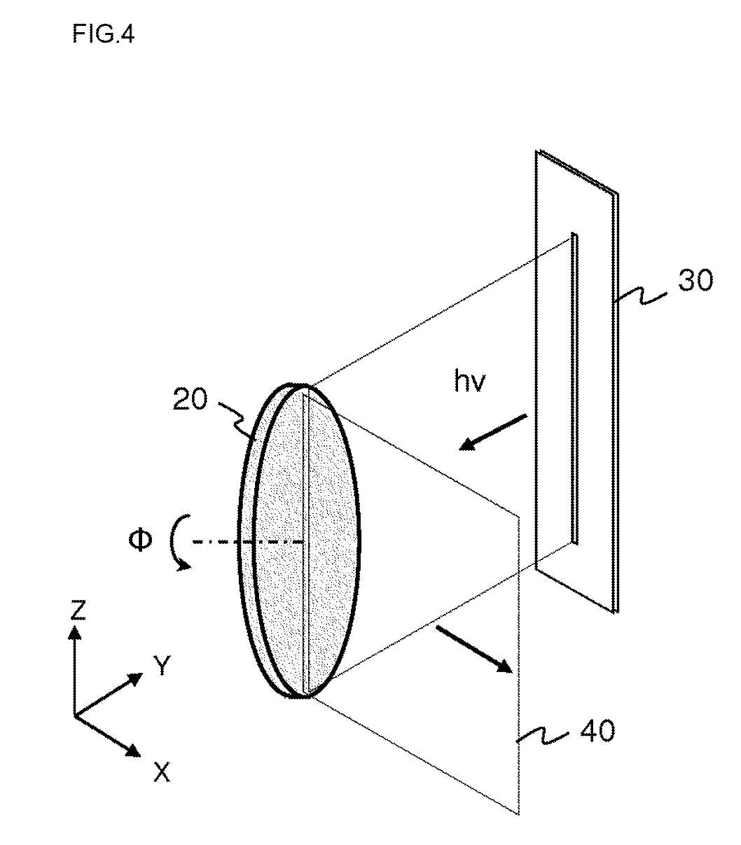

FIG. 4 is a schematic view illustrating another example of a measurement system for obtaining an X-ray diffraction profile from a plate-like specimen 20 by φ scanning. In the example shown in FIG. 4, a slim rectangular region defined by a slit is irradiated with an X-ray, on the region extending between both of the circumferential edges of the plate-like specimen 20. The plate-like specimen 20 is rotated with the center thereof as the center of rotation within the YZ plane (φ=0° to 360°, such that the X-ray-irradiated region scans the whole surface of the plate-like specimen 20.

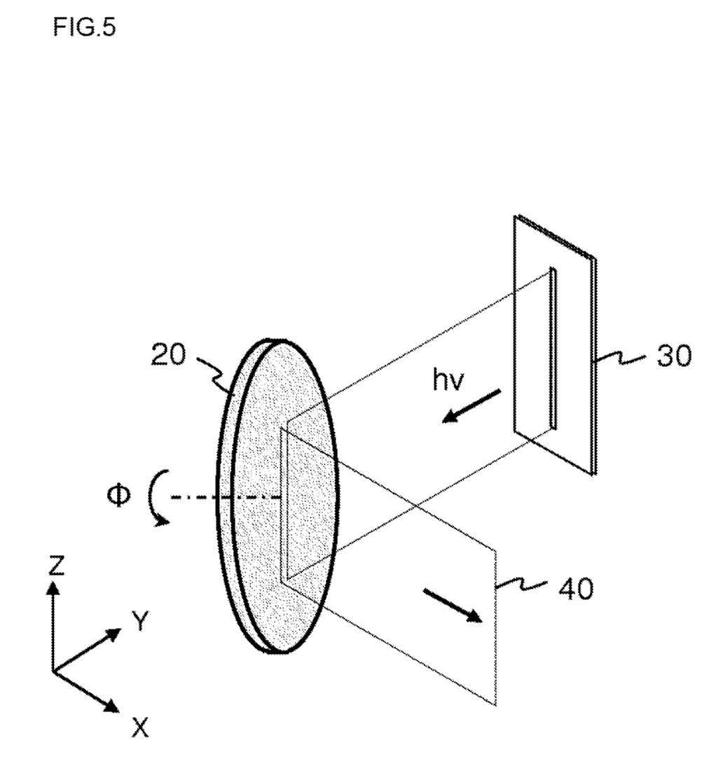

FIG. 5 is a schematic view illustrating yet another example of a measurement system for obtaining an X-ray diffraction profile from a plate-like specimen 20 by φ scanning. In the example shown in FIG. 5, the internal circumferential region only, not the entire principal plane, of the plate-like specimen 20 is irradiated with an X-ray. The plate-like specimen 20 is rotated with the center thereof as the center of rotation within the YZ plane (φ=0° to 360°), such that the X-ray-irradiated region scans the whole surface of the plate-like specimen 20.

A Polycrystalline silicon rod synthesized from monosilane as a raw material has an extremely small difference in the absolute value of the diffraction intensity of X-ray diffraction profile obtained by φ scanning even when the site where the plate-like specimen is collected is different, in comparison with those synthesized from trichlorosilane as a raw material. This means that a polycrystalline silicon rod synthesized from monosilane as a raw material has characteristics including crystallinity with less dependence on the site.

So far, the present inventors have reported that the X-rays diffraction intensity from Miller index planes (111) and (220) can be useful information in evaluation on the crystalline characteristics of a polycrystalline silicon rod in Patent Literature 1 to 4. This is reasonable regardless of whether the raw material is trichlorosilane or monosilane.

Through in-depth examination of many polycrystalline silicon rods, the present inventors found that almost no sharp diffraction peaks are present from Miller index plane (220), in the case of a polycrystalline silicon rod synthesized from monosilane as a raw material. The conceivable reason is that the polycrystalline silicon rod synthesized from monosilane as a raw material hardly contains needle crystals. This is presumed to be related to no occurrence of etching by hydrochloric acid resulting from no formation of hydrochloric acid in the CVD reaction where monosilane is used as a raw material. Plate-like specimens collected from a polycrystalline silicon rod synthesized from monosilane as a raw material as described above are φ-scanned to obtain X-ray diffraction profiles, which roughly display fixed values.

Through evaluation of many polycrystalline silicon rods grown from monosilane as a raw material, the present inventors have come to conclusion that characteristics of polycrystalline silicon rods can be evaluated by “stability” of the Bragg reflection intensity from Miller index planes (hkl).

The term “stability” means that the coefficients of variation CV of the Bragg reflection intensity appearing in a chart obtained by φ scanning a plate-like specimen collected from any of the sites of a polycrystalline silicon rod are small in an aspect, or that the coefficient of variation CV of the respective averages of Bragg reflection intensity appearing in a chart obtained by φ scanning a plurality of plate-like specimens collected from any of the sites of a polycrystalline silicon rod is small in another aspect.

In the case of a polycrystalline silicon rod grown from monosilane as a raw material, the X-ray diffraction intensity from Miller index plane (111) in a chart obtained by φ scanning a plate-like specimen collected from any of the sites is higher than that from Miller index plane (220).

According to the results of investigation by the present inventors, as already described, it is preferred to select a polycrystalline silicon rod having a crystal grain diameter in the range of 0.5 to 10 μm, with an average grain diameter in the range of 2 to 3 μm, as determined from an electron backscatter diffraction image obtained by irradiating the principal plane of a plate-like specimen collected from an arbitrary site with an electron beam, the principal plane being a cross-section perpendicular to the radial direction of the polycrystalline silicon rod, as the raw material for manufacturing a monocrystalline silicon. As long as the grain diameter is in the range, results with an FZ, L % of 99 or more are obtained.

Preferably, the polycrystalline silicon rod has a thermal diffusivity value measured on the principal plane of the plate-like specimen in the range of 75 to 85 mm²/sec at 25±1° C. With use of a polycrystalline silicon rod having a thermal diffusivity out of the range as a raw material for growing an FZ monocrystalline silicon, the crystal line is frequently disarranged. The method for measuring the thermal diffusivity is according to the conditions described in Patent Literature 4.

Also, preferably, the polycrystalline silicon rod has coefficients of variation CV₁⁽¹¹¹⁾ and CV₁⁽²²⁰⁾ of the averages of Bragg reflection intensity from Miller index planes (111) and (220) of 10% or less, and the coefficient of variation CV₂ of the intensity ratio of the average of Bragg reflection intensity of the Miller index plane (111) to the average of Bragg reflection intensity of the Miller index plane (220) obtained for each of a plurality of the plate-like specimens of 3% or less, wherein the plurality of the plate-like specimens with a cross-section perpendicular to the radial direction of the polycrystalline silicon rod as the principal plane are collected from different sites of the polycrystalline silicon rod; each of the collected plate-like specimens is arranged at a position where the Bragg reflection from the Miller index planes (111) and (220) can be detected; the plate-like specimen is in-plane rotated at a rotation angle φ with the center of the plate-like specimen as the center of rotation, such that an X-ray irradiation region defined by a slit φ-scans on the principal plane of the plate-like specimen; a chart showing the dependence of the Bragg reflection intensity from the Miller index planes (111) and (220) on the rotation angle (φ) of the plate-like specimen is obtained; and the averages of the Bragg reflection intensity appearing in the chart from the Miller index planes (111) and (220) are obtained for each of the plate-like specimens.

Also, preferably, when any of the plate-like specimens is collected from a region near the surface of the polycrystalline silicon rods; the polycrystalline silicon rod has the coefficients of variation CV₁⁽¹¹¹⁾ and CV₁⁽²²⁰⁾ of the averages of Bragg reflection intensity from the Miller index planes (111) and (220) of 4% or less; and the coefficient of variation CV₂ of the intensity ratio of the average of the Bragg reflection intensity of the Miller index plane (111) to the average of the Bragg reflection intensity of the Miller index plane (220) of in the range of 1.3 to 2.2%.

Further, preferably, the polycrystalline silicon rod allows a residual stress measurement result of the plate-like specimen by X-ray diffraction to indicate compression, and a residual stress measurement result of a plate-like specimen having a cross-section perpendicular to the axial direction of the polycrystalline silicon rod as the principal plane by X-ray diffraction also to indicate compression.

The synthesis temperature with use of monosilane as a raw material (roughly about 900° C.) is lower than that with use of trichlorosilane, so that the difference between the core temperature and the surface temperature of a polycrystalline silicon rod (ΔT) is inevitably lower than that with use of trichlorosilane as a raw material. The residual stress is therefore lower than that with use of trichlorosilane as a raw material, the compression can be enhanced by appropriately controlling (setting) the CVD reaction temperature.

A polycrystalline silicon with compression is preferred to be grasped with an FZ device. With the presence of tension in a partial site, there is a risk that the grasped rod may crack and fall off. Compression is therefore required.

The residual stress is measured by the following method.

Both of the plate-like specimens perpendicular and parallel to the vertical direction of a rod are evaluated by the slope of the best fit line to the points plotted in a 2θ-sin²Ψ diagram obtained in X-ray diffraction using the least squares approximation (Δ(2θ)/Δ(sin²Ψ)) so as to determine a residual stress σ based on the following expressions.

σ (MPa)=K·[Δ(2θ)/Δ(sin²Ψ)]

K=−(E/2(1+ν))·cot θ₀·π/180
Ψ: angle between specimen surface normal and lattice plane normal (deg.)
θ: diffraction angle (deg.)
K: stress constant (MPa/deg.)=−530.45 MPa/°
E: Young's modulus (MPa), adopting the value for monocrystalline silicon (111), 171.8 GPa
ν: Poisson's ratio, 0.214
θ₀: Bragg angle (deg.) in no distortion, Si (331) at 2θ=133.51°

The X-ray for irradiation is Cr-Kα radiation (40 KV, 40 mA), having a measuring range with a diameter of 2 mm.

### EXAMPLES

### Experiment 1

Polycrystalline silicon rods A, B, C and D having a diameter of about 130 mm synthesized from monosilane as a raw material were prepared. From each of the polycrystalline silicon rods, core samples having a diameter of 19 mm were collected in the manner illustrated in FIGS. 1A and 1B. From arbitrary positions of the core samples, plate-like specimens having a cross-section perpendicular to the radial direction of the polycrystalline silicon rod as the principal plane were collected.

The plate-like specimens were lapped with an abrasive with a grain size of #360, and the surface was etched with hydrofluoric-nitric acid mixture (volume ratio, hydrofluoric acid:nitric acid=1:5) for 1 minute. On this occasion, 50 wt % hydrofluoric acid and 70 wt % nitric acid were used. The surface was then mirror-finished by buffing with use of a 1-μm diamond slurry, and the crystal grain diameter was determined from an electron backscatter diffraction image obtained by irradiating the principal plane of the plate-like specimen with an electron beam.

The results are summarized in Table 1.

TABLE 1

| Polycrystalline | Crystal grain | Average grain | |
|---|---|---|---|
| silicon rod | diameter (μm) | diameter (μm) | FZ, L % |
| A | 0.5-10 | 2.1 | 100 |
| B | 0.5-10 | 2.8 | 99 |
| C | 0.1-10 | 1.6 | 0 |
| D | 0.5-50 | 8.5 | 0 |

Through comprehensive assessment of the results on the similar experiments with use of other polycrystalline silicon rods, the present inventors found that the polycrystalline silicon rods grown from monosilane as a raw material, having a crystal grain diameter in the range of 0.5 to 10 μm, with an average grain diameter in the range of 2 to 3 μm, as determined from an electron backscatter diffraction image obtained by irradiating the principal plane of a plate-like specimen collected from an arbitrary site with an electron beam, the principal plane being a cross-section perpendicular to the radial direction of the polycrystalline silicon rod, have good FZ, L % values.

### Experiment 2

The thermal diffusivity values of the plate-like specimens collected from polycrystalline silicon rods E and F as well as the plate-like specimens collected from the polycrystalline silicon rods A and B were measured. Note that the plate-like specimens collected from the polycrystalline silicon rods E and F have a crystal grain diameter in the range of 0.5 to 10 μm, with an average grain diameter in the range of 2 to 3 μm, as determined from an electron backscatter diffraction image obtained by irradiating the principal plane of a plate-like specimen with an electron beam, as with the plate-like specimens collected from the polycrystalline silicon rods A and B.

The surface of the plate-like specimens was mirror-finished by the procedures described above, and the thermal diffusivity value measured at the principal plane was measured under a condition of a temperature of 25±1° C.

The results are summarized in Table 2.

TABLE 2

| Polycrystalline | Thermal diffusivity | |
|---|---|---|
| silicon rod | (mm²/sec) | FZ, L % |
| A | 77 | 100 |
| B | 83 | 99 |
| E | 65 | 52 |
| F | 55 | 12 |

Through comprehensive assessment of the results on the similar experiments with use of other polycrystalline silicon rods, the present inventors found that the polycrystalline silicon rods grown from monosilane as a raw material, having a crystal grain diameter in the range of 0.5 to 10 μm, with an average grain diameter in the range of 2 to 3 μm, as determined from an electron backscatter diffraction image obtained by irradiating the principal plane of a plate-like specimen collected from any site with an electron beam, the principal plane being a cross-section perpendicular to the radial direction of the polycrystalline silicon rod, further having a thermal diffusivity value measured on the principal plane of the plate-like specimen in the range of 75 to 85 mm²/sec at 25±1° C., have a good FZ, L % value.

The residual stress measurement of the plate-like specimens collected from the polycrystalline silicon rods A and B by X-ray diffraction indicated compression in both of them. In other words, both of the polycrystalline silicon rods A and B had compressive residual stress.

### Experiment 3

Polycrystalline silicon rods G, H, I and J having a diameter of about 130 mm synthesized from monosilane as a raw material were prepared. From each of the polycrystalline silicon rods, core samples having a diameter of 19 mm were collected in the manner illustrated in FIGS. 1A and 1B. From any of the positions of the core samples, 10 plate-like specimens having a cross-section perpendicular to the radial direction of the polycrystalline silicon rod as the principal plane were collected, respectively.

Any of the plate-like specimens collected from the polycrystalline silicon rods G, H, I and J had a crystal grain diameter in the range of 0.5 to 10 μm, with an average grain diameter in the range of 2 to 3 μm, as determined from an electron backscatter diffraction image obtained by irradiating the principal plane of the plate-like specimen with an electron beam, further having a thermal diffusivity value measured on the principal plane of the plate-like specimen in the range of 75 to 85 mm²/sec at 25±1° C.

The plate-like specimens were lapped with an abrasive with a grain size of #360, and the surface was etched with hydrofluoric-nitric acid mixture (volume ratio, hydrofluoric acid:nitric acid=1:5) for 1 minute. On this occasion, 50 wt % hydrofluoric acid and 70 wt % nitric acid were used.

Each of the plate-like specimens was arranged at a position where the Bragg reflection from Miller index planes (111) and (220) can be detected, and in-plane rotated at a rotation angle φ with the center of the plate-like specimen as the center of rotation, such that an X-ray irradiation region defined by a slit φ-scans on the principal plane of the plate-like specimen so as to obtain a chart showing the dependence of the Bragg reflection intensity from the Miller index planes (111) and (220) on the rotation angle (φ) of the plate-like specimen.

The averages of the Bragg reflection intensity from the Miller index planes (111) and (220) in the obtained chart were determined for each of the plate-like specimens, so that the coefficients of variation CV₁⁽¹¹¹⁾ and CV₁⁽²²⁰⁾ of the averages of Bragg reflection intensity from the Miller index planes (111) and (220) were calculated. Further, the CV value (CV₂) of the intensity ratio of the average of Bragg reflection intensity of the Miller index plane (111) to the average of Bragg reflection intensity of the Miller index plane (220) was determined.

The averages of the Bragg reflection intensity from Miller index faces (111) and (220) were calculated from 500 diffraction intensities in a diffraction chart obtained by rotating the plate-like specimen by 180°. Since the averages are determined for each of the plate-like specimens, the same calculation was done for a plurality (number: n) of plate-like specimens so as to obtain a plurality (number: n) of averages. From the plurality of averages, the coefficients of variation CV₁⁽¹¹¹⁾ and CV₁⁽²²⁰⁾ were calculated. The CV value of the intensity ratio is also the same. Since a plurality (number: n) of intensity ratios of the average of Bragg reflection intensity of the Miller index plane (111) to the average of Bragg reflection intensity of the Miller index plane (220) are obtained, the coefficients of variation CV₂ was calculated from the plurality of intensity ratios.

The results are summarized in Table 3.

TABLE 3

| Polycrystalline | | CV value | | CV value of | |
|---|---|---|---|---|---|
| silicon rod | Number: n | (111) | (220) | intensity ratio | FZ, L % |
| G | 10 | 5.4 | 5.9 | 1.4 | 100 |
| H | 10 | 8.6 | 9.6 | 2.9 | 99 |
| I | 10 | 11.8 | 13.3 | 3.7 | 50 |
| J | 10 | 20.4 | 22.3 | 4.5 | 40 |

Through comprehensive assessment of the results on the similar experiments with use of other polycrystalline silicon rods, the present inventors found that the polycrystalline silicon rods grown from monosilane as a raw material, having a crystal grain diameter in the range of 0.5 to 10 μm, with an average grain diameter in the range of 2 to 3 μm, as determined from an electron backscatter diffraction image obtained by irradiating the principal plane of a plate-like specimen collected from an arbitrary site with an electron beam, the principal plane being a cross-section perpendicular to the radial direction of the polycrystalline silicon rod, further having a thermal diffusivity value measured on the principal plane of the plate-like specimen in the range of 75 to 85 mm²/sec at 25±1° C., further satisfying the following conditions, have a good FZ, L % value.

That is to say, the coefficients of variation CV₁⁽¹¹¹⁾ and CV₁⁽²²⁰⁾ of the averages of Bragg reflection intensity from Miller index planes (111) and (220) are 10% or less, and the coefficient of variation CV₂ of the intensity ratio of the average of Bragg reflection intensity of the Miller index plane (111) to the average of Bragg reflection intensity of the Miller index plane (220) obtained for each of a plurality of the plate-like specimens is 3% or less, wherein the plurality of the plate-like specimens with a cross-section perpendicular to the radial direction of the polycrystalline silicon rod as the principal plane are collected from different sites of the polycrystalline silicon rod; each of the collected plate-like specimens is arranged at a position where the Bragg reflection from the Miller index planes (111) and (220) can be detected; the plate-like specimen is in-plane rotated at a rotation angle φ with the center of the plate-like specimen as the center of rotation, such that an X-ray irradiation region defined by a slit φ-scans on the principal plane of the plate-like specimen; a chart showing the dependence of the Bragg reflection intensity from the Miller index planes (111) and (220) on the rotation angle (φ) of the plate-like specimen is obtained; and the average of the Bragg reflection intensity appearing in the chart from the Miller index planes (111) and (220) is obtained for each of plate-like specimens.

### Experiment 4

Polycrystalline silicon rods K, L, M and N having a diameter of about 130 mm synthesized from monosilane as a raw material were prepared. From 3 places of each of the polycrystalline silicon rods, core samples having a diameter of 19 mm were collected in the manner illustrated in FIGS. 1A and 1B. As shown in FIG. 1B, plate-like specimens (20_{CTR}, 20_{EDG}, 20_{R/2}) were collected from a site closest to the silicon core (CTR), a site close to the side of polycrystalline silicon rod (EDG), and a site in the middle between CTR and EDG (R/2), of the core samples, respectively.

Although only 3 pieces of plate-like specimens are shown in FIG. 1B, the plate-like specimens were also collected from the symmetrical positions of the collecting positions of the plate-like specimens (20_{CTR}, 20_{EDG}, 20_{R/2}) in the same manner, so as to obtain the sufficient number n. In the example shown in the Figure, a total of 6 pieces of plate-like specimens were therefore collected for 1 core sample. As described above, 3 pieces of core samples were collected for each of the polycrystalline silicon rods, so that 6 pieces of the plate-like specimens were collected from a site close to the side that is a region near the surface of the polycrystalline silicon rod (EDG), and 6 pieces of the plate-like specimens were collected from a site in the middle between CTR and EDG (R/2), respectively.

Any of the plate-like specimens collected from the polycrystalline silicon rods K, L, M and N had a crystal grain diameter in the range of 0.5 to 10 μm, with an average grain diameter in the range of 2 to 3 μm, as determined from an electron backscatter diffraction image obtained by irradiating the principal plane of the plate-like specimen with an electron beam, further having a thermal diffusivity value measured on the principal plane of the plate-like specimen in the range of 75 to 85 mm²/sec at 25±1° C.

Any of the plate-like specimens was collected from polycrystalline silicon rods satisfying the following conditions.

That is to say, the coefficients of variation CV₁⁽¹¹¹⁾ and CV₁⁽²²⁰⁾ of the averages of Bragg reflection intensity from Miller index planes (111) and (220) are 10% or less, and the coefficient of variation CV₂ of the intensity ratio of the average of Bragg reflection intensity of the Miller index plane (111) to the average of Bragg reflection intensity of the Miller index plane (220) obtained for each of a plurality of plate-like specimens is 3% or less, wherein the plurality of the plate-like specimens with a cross-section perpendicular to the radial direction of the polycrystalline silicon rod as the principal plane are collected from different sites of the polycrystalline silicon rod; each of the collected plate-like specimens is arranged at a position where the Bragg reflection from the Miller index planes (111) and (220) can be detected; the plate-like specimen is in-plane rotated at a rotation angle φ with the center of the plate-like specimen as the center of rotation, such that an X-ray irradiation region defined by a slit φ-scans on the principal plane of the plate-like specimen; a chart showing the dependence of the Bragg reflection intensity from the Miller index planes (111) and (220) on the rotation angle (φ) of the plate-like specimen is obtained; and the averages of the Bragg reflection intensity appearing in the chart from the Miller index planes (111) and (220) are obtained for each of plate-like specimens.

Each of the plate-like specimens was arranged at a position where the Bragg reflection from the Miller index planes (111) and (220) can be detected and in-plane rotated at a rotation angle φ with the center of the plate-like specimen as the center of rotation, such that an X-ray irradiation region defined by a slit φ-scans on the principal plane of the plate-like specimen so as to obtain a chart showing the dependence of the Bragg reflection intensity from the Miller index planes (111) and (220) on the rotation angle (φ) of the plate-like specimen.

The averages of the Bragg reflection intensity from the Miller index planes (111) and (220) appearing in the obtained chart were determined for each of the plate-like specimens, so that the coefficients of variation CV₁⁽¹¹¹⁾ and CV₁⁽²²⁰⁾ of the averages of Bragg reflection intensity from the Miller index planes (111) and (220) were calculated. Further, the CV value (CV₂) of the intensity ratio of the average of Bragg reflection intensity of the Miller index plane (111) to the average of Bragg reflection intensity of the Miller index plane (220) was determined.

The results are summarized in Tables 4 and 5.

TABLE 4

| Polycrystalline | EDG collection | | R/2 collection | | CTR collection | | |
|---|---|---|---|---|---|---|---|
| silicon rod | CV₁⁽¹¹¹⁾ | CV₁⁽²²⁰⁾ | CV₁⁽¹¹¹⁾ | CV₁⁽²²⁰⁾ | CV₁⁽¹¹¹⁾ | CV₁⁽²²⁰⁾ | FZ, L % |
| K | 0.96 | 2.01 | 1.71 | 1.81 | 2.22 | 2.60 | 100 |
| L | 2.24 | 2.45 | 3.78 | 1.99 | 2.69 | 2.87 | 100 |
| M | 4.29 | 4.19 | 3.97 | 3.89 | 4.12 | 3.45 | 95 |
| N | 5.96 | 4.12 | 6.42 | 6.99 | 4.24 | 4.81 | 50 |

TABLE 5

| Polycrystalline | EDG collection | R/2 collection | CTR collection | FZ, |
|---|---|---|---|---|
| silicon rod | CV₂ | CV₂ | CV₂ | L % |
| K | 1.5 | 1.4 | 1.3 | 100 |
| L | 2.2 | 2.1 | 2.0 | 100 |
| M | 2.9 | 2.7 | 2.5 | 95 |
| N | 3.4 | 3.2 | 3.0 | 50 |

Through comprehensive assessment of the results on the similar experiments with use of other polycrystalline silicon rods, the present inventors found that the polycrystalline silicon rods grown from monosilane as a raw material, having a crystal grain diameter in the range of 0.5 to 10 μm, with an average grain diameter in the range of 2 to 3 μm, as determined from an electron backscatter diffraction image obtained by irradiating the principal plane of a plate-like specimen collected from an arbitrary site with an electron beam, the principal plane being a cross-section perpendicular to the radial direction of the polycrystalline silicon rod, further having a thermal diffusivity value measured on the principal plane of the plate-like specimen in the range of 75 to 85 mm²/sec at 25±1° C., further satisfying the following two conditions, have a good FZ, L % value.

That is to say, the first condition is as follows. The coefficients of variation CV₁⁽¹¹¹⁾ and CV₁⁽²²⁰⁾ of the averages of Bragg reflection intensity from Miller index planes (111) and (220) are 10% or less, and the coefficient of variation CV₂ of the intensity ratio of the average of Bragg reflection intensity of the Miller index plane (111) to the average of Bragg reflection intensity of the Miller index plane (220) obtained for each of a plurality of plate-like specimens is 3% or less, wherein the plurality of the plate-like specimens with a cross-section perpendicular to the radial direction of the polycrystalline silicon rod as the principal plane are collected from different sites of the polycrystalline silicon rod; each of the collected plate-like specimens is arranged at a position where the Bragg reflection from the Miller index planes (111) and (220) can be detected; the plate-like specimen is in-plane rotated at a rotation angle φ with the center of the collected plate-like specimen as the center of rotation, such that an X-ray irradiation region defined by a slit φ-scans on the principal plane of the plate-like specimen; a chart showing the dependence of the Bragg reflection intensity from the Miller index planes (111) and (220) on the rotation angle (φ) of the plate-like specimen is obtained; and the averages of the Bragg reflection intensity appearing in the chart from the Miller index planes (111) and (220) are obtained for each of plate-like specimens.

In addition, the second condition is as follows. Any of the plurality of plate-like specimens collected from a region near the surface of a polycrystalline silicon rod has coefficients of variation CV₁⁽¹¹¹⁾ and CV₁⁽²²⁰⁾ of the averages of Bragg reflection intensity from the Miller index planes (111) and (220) of 4% or less, and a coefficient of variation CV₂ of the intensity ratio of the average of Bragg reflection intensity of the Miller index plane (111) to the average of Bragg reflection intensity of the Miller index plane (220) in the range of 1.3 to 2.2%.

### INDUSTRIAL APPLICABILITY

According to the present invention, in manufacturing a raw material for manufacturing monocrystalline silicon from a polycrystalline silicon rod synthesized from monosilane, the polycrystalline silicon rod suitable as a raw material for single crystallization is provided by selecting a polycrystalline silicon rod according to the conditions described above.

The present invention provides a technique for selecting a polycrystalline silicon suitable as a raw material for manufacturing monocrystalline silicon with high quantitativity and reproducibility so as to achieve stable manufacturing of monocrystalline silicon.

### REFERENCE SIGNS LIST

1: SILICON CORE
10: POLYCRYSTALLINE SILICON ROD
11: ROD
20: PLATE-LIKE SPECIMEN
30: SLIT
40: X-RAY BEAM

1-5. (canceled)

6. A polycrystalline silicon rod grown from monosilane as a raw material, having a crystal grain diameter in the range of 0.5 to 10 μm, with an average grain diameter in the range of 2 to 3 μm, as determined from an electron backscatter diffraction image obtained by irradiating a principal plane of a plate-like specimen collected from an arbitrary site with an electron beam, the principal plane being a cross-section perpendicular to the radial direction of the polycrystalline silicon rod.

7. The polycrystalline silicon rod according to claim 6, wherein a residual stress measurement result of the plate-like specimen by X-ray diffraction indicates compression, and a residual stress measurement result of a plate-like specimen having a cross-section perpendicular to the axial direction of the polycrystalline silicon rod as the principal plane by X-ray diffraction also indicates compression.

8. The polycrystalline silicon rod according to claim 6, wherein a thermal diffusivity value measured on the principal plane of the plate-like specimen is in the range of 75 to 85 mm²/sec at 25±1° C.

9. The polycrystalline silicon rod according to claim 8, wherein a residual stress measurement result of the plate-like specimen by X-ray diffraction indicates compression, and a residual stress measurement result of a plate-like specimen having a cross-section perpendicular to the axial direction of the polycrystalline silicon rod as the principal plane by X-ray diffraction also indicates compression.

10. The polycrystalline silicon rod according to claim 8, wherein
the coefficients of variation CV₁⁽¹¹¹⁾ and CV₁⁽²²⁰⁾ of the averages of Bragg reflection intensity from Miller index planes (111) and (220) are 10% or less, and
the coefficient of variation CV₂ of the intensity ratio of the average of Bragg reflection intensity of the Miller index plane (111) to the average of Bragg reflection intensity of the Miller index plane (220) obtained for each of a plurality of plate-like specimens is 3% or less; wherein
the plurality of the plate-like specimens with a cross-section perpendicular to the radial direction of the polycrystalline silicon rod as the principal plane are collected from different sites of the polycrystalline silicon rod;
each of the collected plate-like specimens is arranged at a position where the Bragg reflection from the Miller index planes (111) and (220) can be detected;
the plate-like specimen is in-plane rotated at a rotation angle φ with the center of the plate-like specimen as the center of rotation, such that an X-ray irradiation region defined by a slit φ-scans on the principal plane of the plate-like specimen;
a chart showing the dependence of the Bragg reflection intensity from the Miller index planes (111) and (220) on the rotation angle (φ) of the plate-like specimen is obtained; and
the averages of the Bragg reflection intensity appearing in the chart from the Miller index planes (111) and (220) are obtained for each of the plate-like specimens.

11. The polycrystalline silicon rod according to claim 10, wherein a residual stress measurement result of the plate-like specimen by X-ray diffraction indicates compression, and a residual stress measurement result of a plate-like specimen having a cross-section perpendicular to the axial direction of the polycrystalline silicon rod as the principal plane by X-ray diffraction also indicates compression.

12. The polycrystalline silicon rod according to claim 10, wherein
when any of the plurality of the plate-like specimens is collected from a region near the surface of the polycrystalline silicon rod,
the coefficients of variation CV₁⁽¹¹¹⁾ and CV₁⁽²²⁰⁾ of the averages of the Bragg reflection intensity from the Miller index planes (111) and (220) are 4% or less; and
the coefficient of variation CV₂ of the intensity ratio of the average of the Bragg reflection intensity of the Miller index plane (111) to the average of the Bragg reflection intensity of the Miller index plane (220) is in the range of 1.3 to 2.2%.

13. The polycrystalline silicon rod according to claim 12, wherein a residual stress measurement result of the plate-like specimen by X-ray diffraction indicates compression, and a residual stress measurement result of a plate-like specimen having a cross-section perpendicular to the axial direction of the polycrystalline silicon rod as the principal plane by X-ray diffraction also indicates compression.
